(19) United States
(12) Patent Application Publication
(10) Pub. No.: US 2020/0147634 A1
(43) Pub. Date: May 14, 2020

(54) NOZZLE APPARATUS FOR DISPENSING COLORANT

(71) Applicant: JOTUN A/S, Sandefjord (NO)

(72) Inventors: Roar Aulie Pedersen, Sandefjord (NO); Halvor Midtvik, Larvik (NO); Jakob Johannson, Oslo (NO); Bjørn Halvor Straume, Oslo (NO)

(21) Appl. No.: 16/625,708

(22) PCT Filed: Jul. 11, 2018
(86) PCT No.: PCT/EP2018/068838

§ 371 Date: Dec. 21, 2019

(30) Foreign Application Priority Data
Jul. 12, 2017 (EP) 17181039.3

(51) Int. Cl. B05B 17/06; B05B 15/55

(52) U.S. Cl. CPC B05B 17/063; B05B 15/55

(57) ABSTRACT

A nozzle apparatus is described in relation to dispensing colorant liquid in a paint tinting system. The nozzle apparatus comprises: a nozzle (12, 13) with a passage (14, 15) for a colorant liquid (16), the passage (14, 15) extending to an outlet for dispensing colorant liquid from the nozzle (12, 13); and an ultrasound transducer (20) for applying ultrasonic vibration to the nozzle (12, 13) and/or to liquid (16) at the nozzle outlet.

The present invention relates to a nozzle apparatus for dispensing colorant in a paint tinting system and to a method for dispensing colorant using such a nozzle apparatus.

Paints and similar coating products are used in numerous applications for protection and for aesthetic appearance. There is a requirement for such products to be available in a range of colours and there is a demand for a very wide range of colours as well as for the ability to obtain bespoke colours on demand. However, it is problematic to produce and store multiple different coloured products. The colours required cannot easily be predicted and a large storage space is required in order to hold a stock of all possible colours. As a result, there are difficulties in economically stocking larger numbers of different coloured paints and the like. This applies both for the manufacturer and for the retailer.

Some paint manufacturers have addressed this problem by developing paint tinting systems. Small scale paint tinting systems are used at the retailer's premises and operate on the basis that a variety of colours can be made by adding colorant to a factory produced base paint. Such machines are often referred to as in-store tinting machines. An example of a successful tinting machine is the Multicolor™ system supplied by Jotun A/S of Norway.

A small number of base paints (or other coatings) is provided to the retailer and these can be customised by the addition of colorant, typically in liquid form. Thus, the retailer need only stock three or four base paints spanning the range of light to deep shades and then to finish the paint by adding colorant to get the final colour. This allows for a large number of colours to be made available to the consumer, in relatively small volumes, without the disadvantage of needing to store pre-made coloured paints. The total number of stock keeping units can be reduced by as much as 90% compared to ‘traditional’ stocking of paints in various colours. Similar principles can be applied for paint tinting systems on a larger scale used at larger retailers for applying colorant to batches of paint at a larger scale, as well as to paint tinting systems for mass production of bespoke paints.

The colorant to be added by the paint tinting system may take the form of pigments, pigment concentrates, tinters or dyes, generally provided in a liquid solution or a carrier liquid. Typically a specific paint colour might require 1 to 5 colorants, but a paint tinting machine may have many more available colorants than this, for example 15-25 different colorants in order to produce a full colour range. The colorants are added to the base paint with the amount of colorant and combination of different colorants being controlled by a computer. The colorants that are added may be based on a stored colour combination or can be created by using an algorithm to determine a custom shade, such as a shade for matching a customer's specified colour. The colorant combination will be set for a specific base paint, which may be white or clear, for example.

Paint tinting systems necessarily include a number of storage vessels containing the colorants and a mechanism for conveying the colorant to the base paint and dispensing it via nozzles. This may include various pumps and so on. The system also includes a control system, typically computerised, for setting the required combination of base paint and colorant and for controlling the delivery of colorant. It is important to be able to accurately control the amount of colorant in order to be able to accurately generate a required shade as well as to be able to accurately reproduce the same shade in different batches. After the colorant has been added then it is mixed into the base paint, usually via shaking a sealed paint container.

Previously proposed improvements to such paint tinting systems have focussed on increasing the accuracy of the amount of colorant liquid that is pumped to the nozzles, for example via the use of pumping systems of greater precision and by the addition of metering mechanisms for measuring the colorant that is dispensed. There remains a need for improvements to such paint tinting systems.

Viewed from a first aspect, the present invention provides a nozzle apparatus for dispensing colorant liquid in a paint tinting system, the nozzle apparatus comprising: a nozzle with a passage for a colorant liquid, the passage extending to an outlet for dispensing colorant liquid from the nozzle; and an ultrasound transducer for applying ultrasonic vibration to the nozzle and/or to liquid at the nozzle outlet.

With this nozzle apparatus the ultrasonic vibrations can be used to detach any colorant liquid that has been retained at the nozzle outlet, which may for example be at a tip of the nozzle. Often a droplet of liquid will be retained at the outlet. This may occur due to surface tension or other forces in relation to wetting of the nozzle surface. The inventors have realised that unpredictable retention or detachment of colorant liquid in this way can have a significant impact on the accuracy of the amount of colorant that has been dispensed. By the use of ultrasonic vibration then any remaining liquid can be reliably detached from the outlet of the nozzle. In addition, unwanted retention of colorant liquid at the nozzle outlet can lead to build up of dried colorant on interior and/or exterior parts of the nozzle around the outlet. Such a build-up of dried colorant may act as a contaminant during future use of the nozzle. It can also clog the passage and restrict the flow of colorant liquid. Removal of retained liquid from the outlet via ultrasonic vibration minimises this build-up and allows for more effective operation of the nozzle apparatus, for example with a lesser burden on cleaning and maintenance. Effectively the ultrasonic vibration acts to clean the nozzle each time it is used. The ultrasonic vibration is applied to the colorant liquid itself. This may be done, without the use of a cleaning liquid, i.e. with direct contact between the source of ultrasonic vibrations and the colorant liquid. This means that the nozzle can be immediately re-used with need to flush out any cleaning liquid, and also the colorant liquid can be fully utilised by letting it drop into the tinted paint. Alternatively, a cleaning liquid may be used, for example by arranging the nozzle apparatus for dipping the tip of the nozzle in a bath of a suitable liquid (e.g. a cleaning liquid comprising water for water-based colorants) via relative movement of the nozzle and the bath. In that case the source of ultrasonic vibrations may contact the cleaning liquid, with the cleaning liquid transmitting the ultrasonic vibrations to the nozzle (and to any colorant liquid on the nozzle).

The nozzle apparatus may be arranged such that after a colorant liquid is passed through the nozzle passage and the flow of colorant liquid is stopped then ultrasonic vibration is applied to detach any remaining colorant liquid from the nozzle outlet. Thus, the apparatus may include a controller for controlling the flow of colorant liquid as well as for controlling the ultrasound transducer, and the controller may be arranged such that the ultrasonic vibration is applied after a colorant liquid is passed through the nozzle duct and when the flow of colorant liquid has stopped. The ultrasonic vibration may be applied as soon as the flow of colorant liquid has stopped in order to minimise the time required to detach any remaining liquid. Alternatively the ultrasonic vibration may be applied after a short delay in order to allow for the liquid to stabilise after flow has stopped. In the case where a bath of cleaning liquid is used then the ultrasonic vibration may be applied once the flow of colorant liquid has stopped and after the tip of the nozzle has been dipped into the bath via relative movement of the nozzle and the bath.

The ultrasonic vibration is applied to the nozzle and/or to the colorant liquid at the outlet of the nozzle and in some examples the outlet of the nozzle is at a tip of the nozzle. Thus, ultrasonic vibration may be applied to the tip of the nozzle. This would typically be a downwardly directed tip for dispensing colorant liquid and allowing the liquid to fall with gravity into the base paint, which would be placed below the nozzle in the paint tinting system.

The use of ultrasonic vibration may also allow for removing colorant liquid from at least a part of the passage inside the nozzle, for example a part of the passage adjacent the outlet. This can further enhance the benefits of detaching retained colorant liquid from the nozzle, especially in relation to minimising the build-up of dried colorant liquid within the passage adjacent the outlet.

In example embodiments the ultrasonic vibration is transmitted through the nozzle and the nozzle acts as an ultrasound amplifier. This is discussed further below. In another possible arrangement, as noted above, the tip of the nozzle may be dipped into a cleaning liquid with the cleaning liquid being used to transmit ultrasonic vibrations to the colorant liquid at the nozzle. Alternatively, the ultrasonic vibration may be applied to the colorant liquid at the outlet using an ultrasound horn that is separate to the nozzle, with an end of the ultrasound horn being positioned or positionable adjacent the outlet of the nozzle in order to bring it into contact with any colorant liquid that may be retained at the nozzle outlet. This approach does not require any adaptation of the nozzle, which can hence be of a standard design. An ultrasound horn of conventional design can also be used, and this may be attached to the ultrasound transducer in any suitable fashion, for example with a bolt or other mechanical fixing. The separate ultrasound horn may be supported via an actuator that enables it to move with respect to the nozzle. In this case the ultrasound horn can be kept away from the nozzle whilst colorant liquid is being dispensed in order to avoid hindering the flow of colorant liquid, and then moved closer to the outlet after the flow of liquid has stopped. Optionally, a single ultrasound horn may be useable with multiple different nozzles, such that a paint tinting system incorporating the nozzle apparatus may have a single ultrasound horn and multiple nozzles, each being able to be subject to ultrasound vibration via contact with the ultrasound horn with colorant liquid at the nozzle outlet. This arrangement is particularly suited to paint tinting systems where the nozzles move to a dispensing station and where a container of base paint remains stationary at the dispensing station, since the ultrasound horn may then be located at the dispensing station.

When the ultrasonic vibration is transmitted through the nozzle and the nozzle acts as an ultrasound amplifier then the nozzle and the ultrasound horn may be considered to be combined as a single unit. This has advantages in relation to the overall packaging of the apparatus, since the dual use of the nozzle makes the apparatus more compact. It is also considered to be potentially more effective in detaching colorant liquid from the outlet, since the ultrasonic vibrations are applied over a larger contact area and this contact area is the interface between the colorant liquid and the nozzle. The ultrasound transducer may be attached to the ultrasound nozzle by a suitable fixing, for example a bolt, and this attachment may be at an opposite end to the outlet from the nozzle. In this case the nozzle may be adapted compared to a standard nozzle design in order to increase the effectiveness of the nozzle in transmitting and amplifying the ultrasound vibration. The nozzle shape may taper toward the outlet, e.g. toward the tip of the nozzle, for amplification of the ultrasound vibration as it is transmitted toward the outlet. The material of the nozzle may be selected to improve the transmission of ultrasonic vibrations and increase the strength of the nozzle. For example, the nozzle may comprise a titanium alloy or an aluminium alloy, as compared to the typical use of stainless steel in known paint colorant nozzles. The nozzle may have been formed by machining. Preferably the nozzle has been formed using tempered aluminium or titanium alloy and in the case of machining it is advantageous to avoid overheating in order to maintain the characteristics of the tempered material. Thus the nozzle may comprise aluminium alloy with a T6 temper, for example.

Where the nozzle transmits the ultrasonic vibrations then the passage may have an inlet located at a node point in the vibration pattern of the nozzle. For example, the inlet may be at a surface of the nozzle spaced apart from the outlet, spaced apart from the connection point with the ultrasound transducer, and located to be at a node point. With longitudinal vibration of the nozzle under influence of the ultrasound transducer then a node will be along a plane through the cross-section of the nozzle perpendicular to the longitudinal axis of the nozzle. The passage may extend in a first passage portion from the outlet at a tip of the nozzle along a centre-line of the nozzle until the node point, i.e. until the plane of the node. The passage may then turn through a right angle and extend in a second passage portion that is perpendicular to the centre-line until the inlet at the surface of the nozzle. This arrangement means that parts of the first passage portion located toward the nozzle tip will be vibrated with the ultrasonic vibration and hence detachment of colorant liquid within this portion can be promoted to allow for cleaning of the nozzle outlet. It also means that the second passage portion is generally shielded from vibration due to its location at the node. This allows for the inlet to be connected to a suitable supply of colorant liquid without risk of inadvertent damage to this connection during ultrasonic vibration. It also reduces the stress concentrations within the material of the nozzle around the second passage portion.

The modified nozzle or the separate ultrasound horn may act to increase the amplitude of ultrasound vibration provided by the ultrasound transducer. For example there may be an amplification of 1.5 to 12 times the original amplitude.

The apparatus may be arranged to apply ultrasonic vibrations with a varying amplitude. Different colorants may have differing properties, for example in terms of their density and viscosity, and the optimal amplitude of vibration may vary for different colorant liquids. Thus, by applying ultrasonic vibrations with a varying amplitude, then it is possible to more effectively detach droplets of liquids with differing properties. This can allow for the same nozzle apparatus to be used with different colorant liquid types without the need to calibrate or otherwise adjust the ultrasound vibration.

The ultrasound transducer may supply vibrations at a frequency in the range 20 kHz to 120 kHz. The peak amplitude of the vibration at the ultrasound transducer may be in the range 0.1 to 12 um and the peak amplitude of the vibration at applied to the nozzle outlet and/or the liquid at the nozzle outlet will be amplified as discussed above and may be 1 to 120 um. The peak amplitude is the maximum magnitude of the amplitude with reference to a zero reference, and should not be confused with the peak-to-peak amplitude, which may be twice the peak amplitude. Where the nozzle is used to transmit the ultrasonic vibrations then the frequency that is used might vary depending on the size of the nozzle, which in turn may vary depending on the volume of colorant that is required. It will be appreciated that for an in-store paint tinting system intended to produce smaller volumes then the nozzle may be smaller than a factory paint tinting system intended to produce larger volumes. Lower frequencies may be more suited to larger nozzles and higher frequencies may be more suited to smaller nozzles. Example transducers may vibrate at about 40 kHz or at about 100 kHz. In the case of a nozzle for an in-store paint tinting system the ultrasound transducer may use a frequency of 80 kHz to 120 kHz, for example a frequency of about 100 kHz.

In an embodiment suitable for an in-house tinting system the passage in the nozzle may have a diameter of 1-4 mm, for example a diameter of about 2 mm. In that case the nozzle may have a tapering shape in which a diameter at the tip of the nozzle is slightly larger than the diameter of the passage, the outlet of the passage is at the tip, and the diameter of the nozzle increases along its length. The nozzle may have a circular cross-section. A conical shape could be used, although in general the shape will not taper evenly along the length of the nozzle as with a cone but instead the gradient of the taper may vary, typically with a greater gradient at the tip of the nozzle as well as at the larger diameter end of the tapered section. The largest cross-section of the nozzle through the width of the nozzle (i.e. as opposed to the length of the nozzle) may have a maximum dimension, i.e. a diameter for a circular form, in the range 8-52 mm. The nozzle length and diameter may be determined in accordance with the required geometry for amplification of ultrasound vibration. Typically the nozzle may include a tapered section with a length that is around 1.5-3 times the maximum diameter.

As well as providing advantages in relation to detachment of retained colorant liquid from the nozzle, which may be done after each use of the nozzle, the ultrasound transducer may also optionally be used during other processes, such as during less frequent cleaning and/or maintenance processes. In some cases ultrasonic vibration used alone may dislodge contaminants on the nozzle, such as dried on colorant. In other examples, the nozzle may be cleaned by exposing it to a cleaning liquid with the ultrasonic vibration being used to enhance the effect of the cleaning liquid. The cleaning liquid may be selected for its ability to remove the colorant and thus it may be a solvent or a carrier liquid of the colorant liquid, such as water for water-based colorant liquids. Alternatively or additionally the cleaning liquid may be selected for its behaviour during ultrasonic vibration, for example in relation to the creation and implosion of cavitation bubbles that may aid in removal of contaminants such as dried colorant from surfaces of the nozzle. Water is also known to be suitable for this purpose. The nozzle apparatus may hence be arranged to operate a cleaning cycle including applying ultrasonic vibrations to the nozzle and/or to cleaning liquid in contact with the nozzle. This is particularly suited to the case where the nozzle transmits the ultrasonic vibrations.

In one example the nozzle may be dipped into a container of cleaning liquid and then ultrasonic vibrations may be applied in order to prompt removal of contaminants from the parts of the nozzle that are dipped into the cleaning liquid. In another example, cleaning liquid may be passed along the passage of the nozzle and ultrasonic vibrations may be applied whilst the cleaning liquid is flowing through the passage and/or after flow is stopped and cleaning liquid is retained in the passage. Again, these cleaning processes are particularly suited to use with a nozzle that transmits the ultrasonic vibrations rather than with a separate ultrasound horn, since vibration of the nozzle itself is considered to provide a greater effect over a larger surface of the nozzle, including the interior surface of the passage.

The nozzle apparatus may include a reservoir of the cleaning liquid as a part of a cleaning system arranged to perform cleaning in conjunction with use of the ultrasound transducer as described above. This may be controlled by a controller, such as a dedicated cleaning system controller, or a controller as mentioned above that also controls the use of the ultrasound transducer to detach colorant liquid from the outlet after colorant liquid is dispensed.

The nozzle apparatus is for use in a paint tinting system for dispensing colorant liquid into a base paint. In another aspect, the invention extends to a paint tinting system including the nozzle apparatus. This may be a paint tinting system that has been manufactured with features of the apparatus such as the ultrasound transducer(s). Alternatively, it may be a paint tinting system that has been retrofitted with such features. The paint tinting system may comprise a plurality of nozzles and a plurality of sources of colorant liquid such that different types of colorant can be dispensed via the plurality of nozzles. As is known for existing paint tinting systems, each nozzle may dispense a single type of colorant liquid and the paint tinting system may use different nozzles to dispense different colorant liquids in suitable combinations to achieve a desired colour of paint (or other coating type). The paint tinting system may further include a colorant liquid supply system such as a pumping device for pumping colorant liquids from the sources to the nozzles in order to dispense a desired amount of, and combination of, colorant liquids. This may include colorant liquid supply systems as known for conventional paint tinting systems, such as those supplied by Jotun A/S under the trade name Multicolor™.

The paint tinting system differs from conventional paint tinting systems by the use of an ultrasound transducer to allow for detachment of any retained colorant from the outlet of the nozzle(s).

In one example the paint tinting system has multiple nozzles and each nozzle is coupled to an ultrasound transducer for vibrating the nozzle. Thus, each nozzle may act to transmit and amplify ultrasonic vibrations as discussed above. Advantageously, this system may use an ultrasound generator to provide an electrical signal to several ultrasound transducers. Thus, there may be a single ultrasound generator that is connected to each of a plurality of ultrasound transducers, which may be all of the transducers for the multiple nozzles. The paint tinting system and the nozzle apparatus within the system may be arranged so that the ultrasound generator drives the appropriate ultrasound transducer to detach colorant liquid from a nozzle that has just been used to dispense colorant liquid. It will be appreciated that generally paint tinting systems will use just a single nozzle at once and thus the ultrasound generator can easily be utilised to drive the vibration of any one transducer without the need to increase the capabilities of the generator.

In another example the paint tinting system has multiple nozzles along with a bath of cleaning liquid that can be used with more than one of the nozzles, and optionally with all of the nozzles. Thus, a single bath of cleaning liquid can be provided along with a single source of ultrasonic vibrations, with this being used to ultrasonically clean colorant liquid from each of the nozzles.

In a further aspect, the invention provides a method for use of a nozzle apparatus for dispensing colorant liquid, the nozzle apparatus comprising: a nozzle with a passage for a colorant liquid, the passage extending to an outlet for dispensing colorant liquid from the nozzle; and an ultrasound transducer; and the method comprising applying ultrasonic vibration to the nozzle and/or to liquid at the nozzle outlet.

This method may use an apparatus with any of the features discussed above, and it may be used in a paint tinting system as discussed above. The method may include applying the ultrasonic vibration for the purpose of detaching any colorant liquid that has been retained at the nozzle outlet, which may for example be at a tip of the nozzle. The method may comprise using the ultrasonic vibration to clean the nozzle each time it is used, for example to ensure accuracy in relation to the amount of colorant liquid that is dispensed as well as to reduce the build-up of dried colorant.

The ultrasonic vibration may be applied after a colorant liquid is passed through the nozzle duct and when the flow of colorant liquid has stopped. The ultrasonic vibration may be applied as soon as the flow of colorant liquid has stopped in order to minimise the time required to detach any remaining colorant liquid. Alternatively the ultrasonic vibration may be applied after a short delay in order to allow for the colorant liquid at the outlet to stabilise after flow has stopped. A controller may be used to control the flow of colorant liquid and/or the activation of the ultrasound transducer.

The ultrasonic vibration is applied to the nozzle and/or to the liquid at the outlet of the nozzle and in some examples the outlet of the nozzle is at a tip of the nozzle. Thus, ultrasonic vibration may be applied to the tip of the nozzle. The ultrasonic vibration may also be used for removing liquid from at least a part of the passage inside the nozzle, for example a part of the passage adjacent the outlet.

In example embodiments the ultrasonic vibration is transmitted through the nozzle and the nozzle acts as an ultrasound amplifier. In other embodiments the ultrasonic vibration is transmitted through a cleaning liquid with the tip of the nozzle being dipped into a bath of the cleaning liquid. Alternatively, the ultrasonic vibration may be applied to the liquid at the outlet using an ultrasound horn that is separate to the nozzle, with an end of the ultrasound horn being positioned or positionable adjacent the outlet of the nozzle in order to bring it into contact with any colorant liquid that may be retained at the nozzle outlet. The method can include moving this ultrasound horn as described above, and optionally the method may comprise using a single ultrasound horn with multiple different nozzles, such that a paint tinting system incorporating the nozzle apparatus may have a single ultrasound horn and multiple nozzles.

Where the method includes transmitting ultrasonic vibration through the nozzle then the nozzle acts as an ultrasound amplifier and the nozzle and the ultrasound horn may be considered to be combined as a single unit. The ultrasound transducer may be attached to the ultrasound nozzle by a suitable fixing, for example a bolt, and this attachment may be at an opposite end to the outlet from the nozzle. In this case the nozzle may be adapted compared to a standard nozzle design in order to increase the effectiveness of the nozzle in transmitting and amplifying the ultrasound vibration. The nozzle and the passage within the nozzle may be as described above, for example in relation to geometry, shape, size and/or material and so on.

The method may include applying ultrasonic vibrations with varying amplitude. The frequency of the ultrasound may be as discussed above.

Optionally the method can include using the ultrasound transducer during other processes, such as during cleaning and/or maintenance processes. In some cases ultrasonic vibration may be used alone to dislodge contaminants on the nozzle, such as dried on colorant. In other examples, the method may include cleaning the nozzle by exposing it to a cleaning liquid with the ultrasonic vibration being used to enhance the effect of the cleaning liquid. The cleaning liquid may be selected for its ability to remove the colorant and thus it may be a solvent or carrier liquid of the colorant liquid, such as water for water-based colorant liquids. Alternatively or additionally the cleaning liquid may be selected for its behaviour during ultrasonic vibration, for example in relation to the creation and implosion of cavitation bubbles that may aid in removal of contaminants such as dried colorant from surfaces of the nozzle. Water is also known to be suitable for this purpose. The method may comprise using a cleaning cycle including applying ultrasonic vibrations to the nozzle and/or to cleaning liquid in contact with the nozzle. This is particularly suited to the case where the nozzle transmits the ultrasonic vibrations.

In one example the nozzle may be dipped into a container of cleaning liquid and then ultrasonic vibrations may be applied in order to prompt removal of contaminants from the parts of the nozzle that are dipped into the cleaning liquid. In another example, cleaning liquid may be passed along the passage of the nozzle and ultrasonic vibrations may be applied whilst the cleaning liquid is flowing through the passage and/or after flow is stopped and cleaning liquid is retained in the passage. Again, these cleaning processes are particularly suited to use with a nozzle that transmits the ultrasonic vibrations rather than with a separate ultrasound horn, since vibration of the nozzle itself is considered to provide a greater effect over a larger surface of the nozzle, including the interior of the passage.

The method may use a reservoir of cleaning liquid as a part of a cleaning system of the nozzle apparatus in relation to performing cleaning in conjunction with use of the ultrasound transducer as described above. This may be controlled by a controller, such as a dedicated cleaning system controller, or a controller as mentioned above that also controls the use of the ultrasound transducer to detach colorant liquid from the outlet after colorant is dispensed.

In a yet further aspect the invention extends to a method for dispensing colorant, the method including using a paint tinting system including the nozzle apparatus. The paint tinting system may comprise features as discussed above. The method may include using a single ultrasound generator for driving any one of multiple ultrasound transducers.

As will be appreciated from the above the invention may utilise a controller arranged to carry out method steps including controlling dispensing of colorant liquid as well as controlling the ultrasound transducer. Thus, the invention also includes a computer programme product for a controller of a nozzle apparatus as described above, wherein the computer programme product comprises instructions that, when executed, will configure the controller to: control dispensing of colorant liquid; and control the ultrasound transducer in order to apply ultrasonic vibrations to the nozzle and/or to liquid at the outlet of the nozzle to detach colorant liquid that has been retained at the nozzle outlet. The computer programme product may configure the controller to control the apparatus in accordance with any other features of the apparatus or method described above.

Certain preferred embodiments will now be described by way of example only and with reference to the accompanying drawings, in which

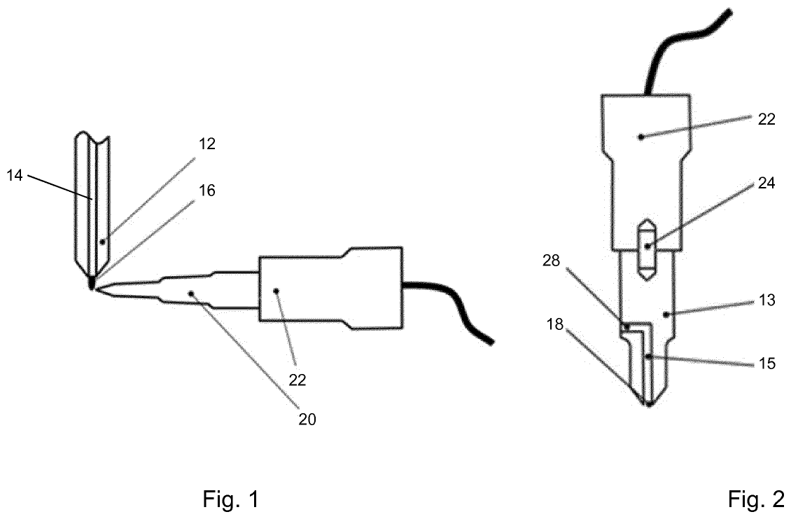

FIG. 1 shows a nozzle apparatus with a nozzle and a separate ultrasound horn;

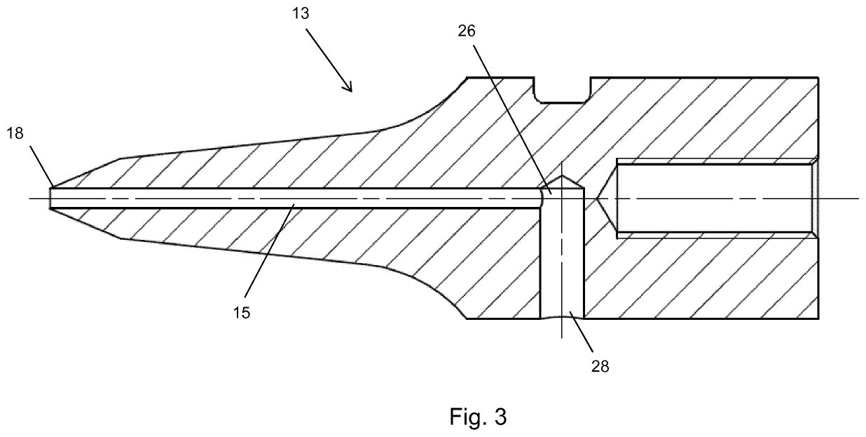

FIG. 2 shows a nozzle apparatus where the nozzle is adapted to also transmit ultrasonic vibrations; and

FIG. 3 is a cross-section of a nozzle for use in the apparatus of FIG. 2.

The preferred embodiments relate to nozzles for dispensing colorant in a paint tinting system. Such a system will typically include multiple nozzles that allow for one or more of multiple different colorants to be dispensed into a base paint in order to transform the base paint into a tinted paint with desired colour characteristics. As discussed above, it is important to ensure that the colorant is dispensed accurately and in particular to avoid retention of unknown amounts of colorant at the nozzle tip. It is also important to keep the nozzle tip clean of colorant to avoid problems caused by dried colorant at the nozzle tip and the outlet for colorant liquid, such as blockages and contamination of paint with dried colorant. Thus, it is proposed to clean the nozzle tip after each use of the nozzle to dispense colorant through the use of a nozzle apparatus including the nozzle as well as an ultrasound transducer.

Two possible implementations for an ultrasound based nozzle cleaning system are shown in FIGS. 1 and 2. In FIG. 1 ultrasound is applied to colorant liquid retained at the nozzle tip by using a separate ultrasound horn that is positioned adjacent the nozzle tip. In FIG. 2 ultrasound is applied via the nozzle itself. Either alternative could be adapted for use in a paint tinting system using multiple nozzles to dispense different types of colorants in order to provide customisable paint colours. For example, they might be implemented in paint tinting systems as sold by Jotun A/S under the trade name Multicolor™.

With reference to FIG. 1, a nozzle 12 has a passage 14 for a colorant liquid 16. The passage 14 extends to an outlet which in this case is at the tip 18 of the nozzle 12. This nozzle 12 may be a generally standard shape and form although it made be adapted by a change of the material in order to withstand ultrasound transmitted into the nozzle by the liquid 16. For example, an aluminium or titanium alloy may be used in place of the usual stainless steel. In use, when flow of the colorant liquid 16 has been stopped then a droplet of the liquid 16 may remain at the tip 18 of the nozzle 12. In order to detach any remaining droplet of colorant liquid 16 an ultrasound horn 20 is placed adjacent to the nozzle tip 18 and this is used to apply vibration to the liquid 16 at ultrasonic frequencies. The ultrasound horn 20 may always be located as shown, or alternatively it may be actuated to move toward and away from the tip 18 so as to avoid any obstacle to colorant liquid 16 being dispensed from the outlet of the nozzle 12 during normal use. The ultrasound horn 20 is coupled to an ultrasound transducer 22 and may vibrate with frequencies and/or amplitudes similar to those discussed below in relation to the embodiment shown in FIG. 2.

In the alternative arrangement of FIG. 2 an adapted colorant dispensing nozzle 13 is used both to dispense colorant liquid 16 and also to transmit and amplify ultrasonic vibrations to detach unwanted remaining liquid 16 from the outlet at the tip 18 of the nozzle 13. The adapted nozzle 13 includes a passage 15 for a colorant liquid 16, which is adapted with reference to the ultrasonic vibration of the nozzle 13 as explained below. As the adapted nozzle 13 also acts as an ultrasound horn then it is coupled directly to the ultrasound transducer 22 via a bolt 24. The adapted nozzle 13 is also shaped to act as an ultrasound booster. This is shown schematically in FIG. 2, and one example of an adapted nozzle 13 shown to scale is found in FIG. 3, which shows a cross-section of a nozzle 13 that is designed to be attached to an ultrasound transducer 22 and to transmit and amplify ultrasonic vibrations. It has been found that transmitting the vibrations via the nozzle 13 can be more effective at detaching retained droplets of colorant liquid 16 from the tip 18 than using a separate ultrasound horn 20 as in FIG. 1.

FIG. 3 shows a cross-section of an adapted nozzle 13 that is designed to be attached to an ultrasound transducer 22. The nozzle 13 includes a passage 15 for colorant liquid 16. The passage 15 extends longitudinally along a centreline of the nozzle 13 from an outlet at the tip 18 to a turn point 26 where the passage 15 turns a right angle and then extends radially to an inlet port 28 at the side of the nozzle 13. The port 28 allows for onward connection to tubing or similar for coupling the passage 15 to a source of colorant liquid. The turn point 26, the port 28 and the radial part of the passage 15 are located at a node of the vibrational pattern of the adapted nozzle 13. Thus, they are at all located in a region that experiences minimum (or zero) movement whilst the nozzle 13 is being vibrated. This means that there is no undue movement or stress on the port 28 or the connections at the port 28. It also allows for reductions in stress concentrations in the material of the nozzle 13 arising from vibrational movements of the material around the passage 15. As shown in FIG. 3 the nozzle 13 includes a threaded hole 30 to enable it to be joined to an ultrasound transducer 20 with a bolt 24 in a similar way to the nozzle 13 of the schematic view of FIG. 2.

During use of the nozzle apparatus a colorant liquid 16 is passed through the passage 14, 15 and dispensed into a base paint. This can be in the context of any suitable paint tinting system. When the flow of colorant liquid 16 is stopped then the ultrasound transducer 20 is activated and ultrasonic vibration is transmitted either as shown in FIG. 1, directly to the liquid 16 at the tip 18 of the nozzle 12, or as shown in FIG. 2, through the adapted nozzle 13 to the tip 18 and hence to any colorant liquid 16 retained at the tip 18. As a result of the ultrasonic vibration any droplet of colorant liquid 16 that is retained at the tip 18 is detached from the tip 18 and falls into the paint.

This has various advantages. The amount of colorant liquid 16 that can be dispensed can be more accurately known and controlled, since there is no longer any uncertainty about whether or not a droplet of liquid will remain attached to the nozzle tip 18 once the flow of liquid has stopped. Liquid may also detach from within the passage 14, 15 inside the nozzle 12, 13, especially in the case of the adapted nozzle 13 where the whole nozzle 13 is vibrated by the ultrasound transducer. The risk of build-up of dried colorant liquid at the nozzle tip 18 and within the end of the passage 14, 15 is reduced since the colorant liquid is detached, and where the colorant liquid is also detached from the inside of the passage 14, 15 then this benefit arises for some distance within the passage 14, 15 as well.

The ultrasound vibration can be applied at a frequency suited to the design and size of the nozzle 13 or the ultrasound horn 20. Known types of ultrasound transducer 20 can be used to provide such vibrations. It is expected that frequencies of between 30 kHz to 120 kHz may be used, such as a frequency of about 100 kHz for a smaller sized nozzle, or a frequency of about 55 kHz for a larger sized nozzle. The amplitude of the ultrasound vibration may be about 50 μm at the tip 18, amplified from perhaps 5 μm at the ultrasound transducer 22. In some examples the amplitude of the vibrations is varied, for example it may be cycled through an amplitude from 30 μm to 80 μm at the tip 18. As explained above varying amplitude can allow for a single set-up for the nozzle apparatus to be used for colorant liquids of varying properties, such as varying density and or viscosity.

The ultrasound transducer 22 receives an electrical signal from a suitable ultrasound generator. In the case of a paint tinting system with multiple nozzles 12, 13 then each nozzle 12, 13 can have its own ultrasound transducer 22 with a common ultrasound generator being electrically connected to all of the transducers 22. It will be appreciated that in such a paint tinting system then colorant will be dispensed separately from the various nozzles and thus that the ultrasound can be applied separately and at different times. This means that the ultrasound generator need only ever operate a small number of transducers at any one time, perhaps only a single transducer at a time, and therefore it is efficient to have only a single ultrasound generator for the whole system.

A paint tinting system using the proposed nozzle apparatus would include a plurality of sources of colorant liquids, each of which may include a reservoir and a pumping system for supplying each colorant liquid 16 to a respective nozzle 12, 13. A metering system of known type could also be included. This metering system can be calibrated with measurements including the use of ultrasound to detach retained colorant liquid 16 from the nozzle top 18, which allows for accurate and repeatable dispensing of colorant liquid 16 even when small quantities are needed. The nozzles and associated liquid distribution systems can be mounted on a carousel or other suitable arrangement for aligning the required nozzle with a container of a base paint for dispensing of colorant into the base paint. Other features of such paint tinting systems as are known in the prior art may also be present.

In addition to the use of ultrasonic vibration to detach colorant liquid 16 from the nozzle tip 18 the nozzle apparatus may also be arranged to use ultrasound to enhance cleansing of the nozzle 12, 13 during maintenance or as a part of an automated cleaning cycle. With this feature a cleaning liquid may be used, for example this could be water in the case of water soluble/water-based colorant liquids. The nozzle 12, 13, or parts of the nozzle 12, 13 such as the passage 14, 15 or the tip 18 may be placed into contact with the cleaning liquid and ultrasonic vibration may be used to detach any contaminants, such as dried colorant, from surfaces of the nozzle 12, 13.

Thus, in one example the nozzle 12, 13 can be dipped in to a container of cleaning liquid with the tip 18 submerged. The cleaning liquid can then be vibrated via the ultrasound horn 20, or the nozzle 13 can be vibrated with the tip 18 submerged. This will detach contaminants such as dried colorant or dirt of other types from the tip 18 as well as from the interior of the passage 14, 15 adjacent the tip 18. Another possibility is to flow cleaning liquid through the passage 14, 15 and to subject the nozzle to ultrasound vibration whilst the passage 14, 15 is full of cleaning liquid. It is expected that this may be more effective with vibration of the adapted nozzle 13 rather than with vibration from an external ultrasound horn 20, since the walls of the passage 15 in the adapted nozzle 13 it may be difficult for vibrations to propagate into the passage 14.

1. A nozzle apparatus for dispensing colorant liquid in a paint tinting system, the nozzle apparatus comprising:
a nozzle with a passage for a colorant liquid, the passage extending to an outlet for dispensing colorant liquid from the nozzle; and
an ultrasound transducer for applying ultrasonic vibration to the nozzle and/or to liquid at the nozzle outlet.

2. A nozzle apparatus as claimed in claim 1, wherein the nozzle apparatus is arranged such that after a liquid is passed through the nozzle duct and the flow of liquid is stopped then ultrasonic vibration is applied to detach any remaining liquid from the nozzle outlet.

3. A nozzle apparatus as claimed in claim 1 or 2, including a controller for controlling the flow of liquid as well as for controlling the ultrasound transducer, wherein the controller is arranged such that the ultrasonic vibration is applied after a liquid is passed through the nozzle duct and when the flow of liquid has stopped.

4. A nozzle apparatus as claimed in any preceding claim, comprising an ultrasound horn that is separate to the nozzle, wherein the ultrasonic vibration is applied to the liquid at the outlet of the nozzle using the ultrasound horn that is separate to the nozzle, and wherein an end of the ultrasound horn is positioned or positionable adjacent the outlet of the nozzle in order to bring it into contact with any colorant liquid that may be retained at the nozzle outlet.

5. A nozzle apparatus as claimed in any of claims 1 to 3, wherein the ultrasonic vibration is transmitted from the ultrasound transducer through the nozzle and the nozzle acts as an ultrasound amplifier.

6. A nozzle apparatus as claimed in claim 5, wherein the nozzle comprises a titanium alloy or an aluminium alloy.

7. A nozzle apparatus as claimed in claim 5 or 6, wherein the passage has an inlet located at a node in the vibration pattern of the nozzle.

8. A nozzle apparatus as claimed in claim 8, wherein the passage extends in a first passage portion from the outlet at a tip of the nozzle along a centre-line of the nozzle until the node point, and then the passage turns to extend in a second passage portion that is perpendicular to the centre-line and connects to the inlet at the surface of the nozzle.

9. A nozzle apparatus as claimed in any preceding claim, wherein the apparatus is arranged to apply ultrasonic vibrations with a varying amplitude.

10. A nozzle apparatus as claimed in any preceding claim, wherein the ultrasound transducer vibrates at a frequency in the range 20 kHz to 120 kHz, the peak amplitude of the vibration at the ultrasound transducer is in the range 0.1 to 12 um and the peak amplitude of the vibration at applied to the nozzle outlet and/or the liquid at the nozzle outlet is amplified compared to the peak amplitude of the vibration at the ultrasound transducer and is in the range 1 to 120 um.

11. A nozzle apparatus as claimed in any preceding claim, wherein the passage in the nozzle has a diameter of 1-4 mm and optionally, wherein the largest cross-section through the width of the nozzle has a maximum dimension in the range 8-52 mm.

12. A nozzle apparatus as claimed in any preceding claim, wherein the nozzle apparatus is arranged to operate a cleaning cycle including applying ultrasonic vibrations to the nozzle and/or to cleaning liquid in contact with the nozzle, and optionally wherein the nozzle apparatus comprises a reservoir of cleaning liquid as a part of a cleaning system used in the cleaning cycle.

13. A nozzle apparatus as claimed in claim 12, wherein the nozzle apparatus is configured such that during the cleaning cycle the nozzle is dipped into a container of cleaning liquid and ultrasonic vibrations are applied.

14. A nozzle apparatus as claimed in claim 13 or 14, wherein the nozzle apparatus is configured such that during the cleaning cycle a cleaning liquid is passed along the passage of the nozzle and ultrasonic vibrations are applied whilst the cleaning liquid is flowing through the passage and/or after flow of the cleaning liquid is stopped.

15. A paint tinting system including a nozzle apparatus as claimed in any preceding claim.

16. A paint tinting system as claimed in claim 15, comprising: multiple nozzles, wherein each nozzle is coupled to an ultrasound transducer for vibrating the nozzle; and an ultrasound generator arranged to provide an electrical signal to several ultrasound transducers.

17. A method for use of a nozzle apparatus in dispensing colorant liquid, the nozzle apparatus comprising: a nozzle with a passage for a colorant liquid, the passage extending to an outlet for dispensing colorant liquid from the nozzle; and an ultrasound transducer; and the method comprising applying ultrasonic vibration to the nozzle and/or to liquid at the nozzle outlet.

18. A method as claimed in claim 17, the method comprising applying the ultrasonic vibration after a colorant liquid is passed through the nozzle duct and when the flow of colorant liquid has stopped, wherein the ultrasonic vibration is applied for the purpose of detaching any colorant liquid that has been retained at the nozzle outlet.

19. A method as claimed in claim 17 or 18, including cleaning the nozzle by exposing it to a cleaning liquid and using ultrasonic vibration to enhance the effect of the cleaning liquid.

20. A computer programme product for a controller of a nozzle apparatus as claimed in any of claims 1 to 14, wherein the computer programme product comprises instructions that, when executed, will configure the controller to: control dispensing of colorant liquid; and control the ultrasound transducer in order to apply ultrasonic vibrations to the nozzle and/or to liquid at the outlet of the nozzle to detach colorant liquid that has been retained at the nozzle outlet.
